(19) United States
(12) Patent Application Publication
(10) Pub. No.: US 2004/0192396 A1
(43) Pub. Date: Sep. 30, 2004

(54) Method of accessing a service via a mobile telephone network taking account of "data" link quality

(76) Inventor: Jean-Philippe Fournier, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/672,693

(22) Filed: Sep. 25, 2003

(30) Foreign Application Priority Data
Sep. 26, 2002 (FR) 0211947

(51) Int. Cl. H04Q 7/20; H04B 1/38; H04M 1/00

(52) U.S. Cl. 455/563; 455/552.1; 455/445

(57) ABSTRACT

The invention provides a method of accessing a service via a mobile telephone network in which instructions are input by means of a mobile telephone and the instructions are transmitted over a data channel of the mobile telephone network to a server, voice recognition means being suitable for interpreting the instructions, and the server being suitable for performing a task as a function of such interpretation, wherein a parameter relating to the quality of transmission over the data channel of the network is measured, and wherein:

if the quality parameter is above a certain threshold, the telephone is put into a mode of operation in which it is capable of taking account of instructions in voice form and of converting them into data for transmission to the server; and

in the event of the quality parameter being below the threshold, the telephone is put into a mode of operation in which instructions are input in graphics form and the instructions are transmitted to the server.

The invention relates to the field of services offered by mobile telephone networks. By way of example, these services consist in searching for information in databases, navigating the Internet, the web, WAP, or I-Mode, ordering goods, etc.

### BACKGROUND OF THE INVENTION

Systems are known for giving access to Internet sites in which the user of a mobile telephone makes a connection with a server that enables the user to establish contact with other servers and obtain information.

By way of example, there exist navigation systems comprising a web server, a web navigator, and voice recognition means coupling the server with a mobile telephone network. The voice recognition means enable a user of the network to receive graphics data supplied by the server via a web navigator as a function of voice commands issued by the user. That navigation system enables a mobile telephone user to make a connection with a server and to utter navigation or downloading orders in natural language.

In such systems, the user's voice is converted into a “data” signal and is conveyed to the server via a “data” channel of the network.

A drawback of such systems is that in some circumstances, voice transmission over the “data” channel can be disturbed, thereby giving rise to errors in the signal as received.

This means that the voice recognition means cannot identify correctly the words that have been uttered by the user. This drawback is particularly troublesome when the user is making use of paid for services.

### OBJECTS AND SUMMARY OF THE INVENTION

An object of the invention is to enable a mobile telephone user to make use of the services offered by a mobile telephone network even when the quality of voice transmission over the “data” channel is insufficient.

To this end, the invention provides a method of accessing a service via a mobile telephone network in which instructions are input by means of a mobile telephone and the instructions are transmitted over a data channel of the mobile telephone network to a server, voice recognition means being suitable for interpreting the instructions, and the server being suitable for performing a task as a function of such interpretation, wherein a parameter relating to the quality of transmission over the data channel of the network is measured, and wherein:

if the quality parameter is above a certain threshold, the telephone is put into a mode of operation in which it is capable of taking account of instructions in voice form and of converting them into data for transmission to the server; and

in the event of the quality parameter being below the threshold, the telephone is put into a mode of operation in which instructions are input in graphics form (e.g. by using the telephone keypad or a stylus on a touch-sensitive screen) and the instructions are transmitted to the server.

Such a method makes it possible advantageously to go from a “multimode” mode in which the user can formulate requests in natural language or graphically, to a mode that is exclusively a “graphics” mode in which the user selects or inputs an instruction via the keypad of the mobile telephone or by using a stylus, whenever the quality of the data link is not sufficient for conveying voice instructions.

In an implementation of the invention, in order to measure a parameter relating to the quality of the network, a test message is sent, and after being received it is compared with a reference message, and a data channel transmission quality parameter is deduced therefrom.

In particular, the transmission quality parameter is determined as a function of the error rate in the received message relative to the reference message.

In another implementation of the method of the invention, the transmission parameter is determined as a function of jitter, latency, or binary error rate measured during data transmission over the data channel.

In another implementation, in order to measure a parameter relating to network quality, a test message is sent and transmission time of the message is measured, with a data channel transmission quality parameter being deduced therefrom.

Advantageously, the measured message transmission time is the time between the message being sent and the message being received by the network.

In another implementation, in order to measure a parameter relating to network quality, variations are detected in the quantity of data in an output buffer memory of the mobile telephone, and an occupation or congestion parameter for the data channel is deduced therefrom.

In another implementation, in order to measure a parameter relating to the quality of the network, a test message is sent and for each data packet sent, the value is calculated of the checksum relating to the bits in the packet, this value being transmitted to the server together with the data packet, and when the server receives the test message, it calculates for each received data packet the value of the checksum for the bits of the packet, it compares the calculated value with the transmitted value, and it deduces therefrom a network transmission loss parameter.

Advantageously, information is displayed on the screen of the mobile telephone relating to the transmission quality of the data channel.

For example, the information is presented on the screen in the form of a quality indicator.

The invention also provides a mobile telephone including means for receiving instructions in voice form and for converting them into data for transmission to a network, the telephone including means for measuring a parameter relating to the quality of the data link of the mobile telephone network, and as a function of said parameter the mobile telephone is suitable for switching between one and the other of the modes of operation as defined above.

In an embodiment, the mobile telephone includes means for generating a test message over the data channel of the mobile telephone network, and processor means for comparing a message which is returned thereto with a reference message and for deducing therefrom a transmission error rate in the returned message.

In another embodiment of the invention, the mobile telephone includes means for generating a test message over the data channel of the mobile telephone network, and processor means for measuring a time interval between sending the test message and receiving a message which is returned thereto.

Advantageously, the mobile telephone includes means for giving the user information relating to the measured quality of the data link.

The invention also provides an access system for accessing services via a mobile telephone network, the system comprising a mobile telephone, a management server connected to the mobile telephone network, and voice recognition means, the mobile telephone including means for receiving instructions in voice form and for converting them into data for transmission to the server over a data channel of the network, the voice recognition means being suitable for interpreting the instructions, and the server being suitable for performing a task as a function of said interpretation, the system further comprising means for measuring a parameter relating to the quality of the data link of the mobile telephone network, and as a function of this parameter, the telephone is suitable for passing between one and the other of the modes of operation as defined above.

In an embodiment of the invention, the means for measuring a parameter relating to the quality of the data link include means for generating a test message over the data channel of the mobile telephone network and means for receiving said test message, together with processor means for comparing the received message with a reference message and for deducing therefrom a transmission error rate in the received message.

In another embodiment of the invention, the means for measuring a parameter relating to the quality of the data link include means for generating a test message over the data channel of the mobile telephone network and means for receiving the test message, together with processor means for measuring a time interval between the test message being sent and being received.

### BRIEF DESCRIPTION OF THE DRAWING

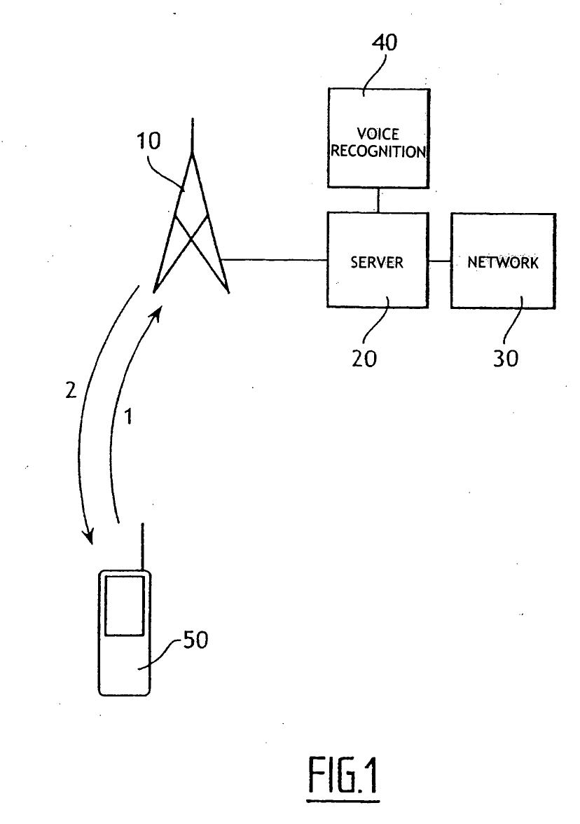

Other characteristics and advantages of the invention appear further from the following description which is purely illustrative and non-limiting and which should be read with reference to accompanying FIG. 1 which represents apparatus for navigating on the Internet and constituting an embodiment of the invention.

### MORE DETAILED DESCRIPTION

In FIG. 1, the navigation apparatus comprises a management server 20 connected to a mobile telephone network 10. The management server is also connected to voice recognition and synthesis means 40 and to an information network 30, e.g. of the Internet type.

The user of a mobile telephone 50 seeking a service may establish a connection with the management server 20 by navigating on the web, WAP, or I-mode, or by ordering direct access to the server 20. The mobile telephone 50 has a data channel and optionally a voice channel.

A page is displayed on the screen of the mobile telephone 50 informing the user that a search for a service can be made by uttering a voice request. By way of example, the service may consist in searching for information, downloading a film, a video sequence or a sound sequence (a radio broadcast or a TV broadcast, music), an animation, a program, etc.

When the user accesses such a page, the server 20 is ready to receive a voice request from the user and it controls the voice recognition means 40 so as to cause it to process the user's request.

The user utters a word or a series of words corresponding to the request. The telephone 50 converts the request into data packets which are transmitted to the access server in this form via the data channel of the network. The access server 20 forwards the request to the voice recognition means 40. The voice recognition means 40 receives and interprets the requests from the user. It returns an interpretation of the user's request to the access server 20.

As a function of this interpretation, the server 20 is adapted to establish connections with databases or with other servers of the network 30 that offer services.

For example, the user may consult geographical guidance information. The user makes a connection to a web, WAP, or I-mode service in “graphics” mode using the keypad of the telephone or using a stylus when the telephone has a touch-sensitive screen. Once connected to the service, a page is displayed on the screen of the telephone specifying the information that can be supplied in the form of fields for filling in. The user can then utter information specifying the place to which the user desires to go. The server processes the request and returns a map of the selected location to the user.

The user may be guided by audio messages that are prerecorded or that are generated by the voice synthesis means 40, or indeed the user may be guided by graphics instructions giving guidance information. The user responds to the questions for filling in the fields in the visual interface of the telephone or indeed for activating a link or loading a page.

In an implementation of the invention, the mobile telephone 50 has processor means suitable for measuring a parameter that is representative of the quality of the data link. For this purpose, the telephone is suitable for generating a test message 1 on the data channel of the network 10. The server 20 receives the message and returns it to the mobile telephone 50. During this exchange, the test message may be degraded. The mobile telephone compares the message 2 that it receives from the network 10 with a reference message, e.g. the initial test message 1. The telephone deduces a transmission error rate therefrom. The telephone compares the error rate with a threshold in order to determine whether the quality of the link is sufficient for conveying voice messages.

By way of example, the test message is a generic message that is sent to the server at regular intervals by the user's mobile telephone 50.

Other parameters may be taken into account in order to determine the quality of the data link. For example, the telephone may measure the go-and-return transmission time for the test message. It compares this time with a threshold to deduce whether the quality of the link is sufficient for conveying voice messages.

It is also possible to measure the time interval between the test message being sent and the message being received by the network 10, this time interval then being compared with a threshold value in order to deduce the quality of the link.

The mobile telephone 50 may also detect variations in the quantity of data in one of its output buffer memories and deduce therefrom a parameter representative of the occupation or congestion of the data channel.

The mobile telephone 50 may also send a test message to the server 10 together with data packets corresponding to the message giving information relating to the value of the checksum relating to the bits in the packet. When the server 10 receives the test message, it calculates for each received data packet the value of the checksum relating to the bits in the packet. It compares this sum with the value sent by the mobile telephone 50 and it deduces therefrom a parameter representative of transmission loss in the network. This transmission loss parameter gives an indication concerning the quality of the data link.

Naturally, other methods of evaluating the quality of the data link may be used. For example it is possible to measure the quality of the network by using conventional techniques for measuring jitter, latency, or indeed binary error during transmission of information over the data channel.

These various methods of evaluation may also be combined in order to deduce therefrom a quality parameter for the data link based on a plurality of criteria.

When the quality of the data link is not sufficient, then the telephone 50 informs the user that voice mode navigation is not possible and it switches to graphics mode navigation. A message is displayed on the screen of the telephone 50 to warn the user.

This changeover from the “multimode” mode of operation to purely “graphics” mode operation can be commanded by the server 20. Nevertheless, it is preferably commanded by the mobile telephone 50 insofar as communication with the server 20 is degraded.

In “graphics” mode navigation, the user selects or inputs instructions via the keypad of the mobile telephone.

The sending of a test message 1 and measuring the quality of the data link can be performed periodically. In this way, the telephone passes from a graphics mode of navigation to a voice mode and vice versa as a function of the quality of the link, but without interrupting navigation.

The telephone 50 may advantageously include a quality indicator which is displayed on the screen to keep the user continuously informed about the quality of the data link. This indicator may be in the form of a lamp, a diagram, an index, or in any other form.

In a variant of the invention, it is the server 20 which determines the quality of the data link between the telephone 50 and the network 10. For this purpose, the telephone generates a test message over the data channel of the network 10. The server 20 receives the message and compares it with a reference message, this reference message possibly being identical to the test message as initially generated by the telephone. A transmission error rate is deduced therefrom. A message is then sent to the telephone 50 containing information about the quality of the data link of the network 10.

In another variant of the invention, it is the server 20 which generates a test message. The telephone 50 can determine directly the quality of the data network link by comparing the message with a reference message, or by returning the message to the server so that the server determines said quality.

What is claimed is:

1. A method of accessing a service via a mobile telephone network in which instructions are input by means of a mobile telephone and the instructions are transmitted over a data channel of the mobile telephone network to a server, voice recognition means being suitable for interpreting the instructions, and the server being suitable for performing a task as a function of such interpretation, wherein a parameter relating to the quality of transmission over the data channel of the network is measured, and wherein:
if the quality parameter is above a certain threshold, the telephone is put into a mode of operation in which it is capable of taking account of instructions in voice form and of converting them into data for transmission to the server; and
in the event of the quality parameter being below the threshold, the telephone is put into a mode of operation in which instructions are input in graphics form and the instructions are transmitted to the server.

2. A method according to claim 1, wherein, in order to measure a parameter relating to the quality of the network, a test message is sent, and after being received it is compared with a reference message, and a data channel transmission quality parameter is deduced therefrom.

3. A method according to claim 2, wherein the transmission quality parameter is determined as a function of the error rate in the received message relative to the reference message.

4. A method according to claim 2, wherein the transmission parameter is determined as a function of jitter, latency, or binary error rate measured during data transmission over the data channel.

5. A method according to claim 1, wherein, in order to measure a parameter relating to network quality, a test message is sent and transmission time of the message is measured, with a data channel transmission quality parameter being deduced therefrom.

6. A method according to claim 4, wherein the measured message transmission time is the time between the message being sent and the message being received by the network.

7. A method according to claim 1, wherein, in order to measure a parameter relating to network quality, variations are detected in the quantity of data in an output buffer memory of the mobile telephone, and an occupation or congestion parameter for the data channel is deduced therefrom.

8. A method according to claim 1, wherein, in order to measure a parameter relating to the quality of the network, a test message is sent and for each data packet sent, the value is calculated of the checksum relating to the bits in the packet, this value being transmitted to the server together with the data packet, and when the server receives the test message, it calculates for each received data packet the value of the checksum for the bits of the packet, it compares the calculated value with the transmitted value, and it deduces therefrom a network transmission loss parameter.

9. A method according to claim 1, wherein information is displayed on the screen of the mobile telephone relating to the transmission quality of the data channel.

10. A method according to claim 9, wherein the information is presented on the screen in the form of a quality indicator.

11. A mobile telephone including means for receiving instructions in voice form and for converting them into data for transmission to a network, the telephone including means for measuring a parameter relating to the quality of the data link of the mobile telephone network, and as a function of said parameter the mobile telephone is suitable for switching between one and the other of the modes of operation defined in claim 1.

12. A mobile telephone according to claim 11, including means for generating a test message over the data channel of the mobile telephone network, and processor means for comparing a message which is returned thereto with a reference message and for deducing therefrom a transmission error rate in the returned message.

13. A mobile telephone according to claim 12, including means for generating a test message over the data channel of the mobile telephone network, and processor means for measuring a time interval between sending the test message and receiving a message which is returned thereto.

14. A mobile telephone according to claim 11, including means for giving the user information relating to the measured quality of the data link.

15. An access system for accessing services via a mobile telephone network, the system comprising a mobile telephone, a management server connected to the mobile telephone network, and voice recognition means, the mobile telephone including means for receiving instructions in voice form and for converting them into data for transmission to the server over a data channel of the network, the voice recognition means being suitable for interpreting the instructions, and the server being suitable for performing a task as a function of said interpretation, the system further comprising means for measuring a parameter relating to the quality of the data link of the mobile telephone network, and as a function of this parameter, the telephone is suitable for passing between one and the other of the modes of operation defined in claim 1.

16. An access system according to claim 15, wherein the means for measuring a parameter relating to the quality of the data link include means for generating a test message over the data channel of the mobile telephone network and means for receiving said test message, together with processor means for comparing the received message with a reference message and for deducing therefrom a transmission error rate in the received message.

17. An access system according to claim 15, wherein the means for measuring a parameter relating to the quality of the data link include means for generating a test message over the data channel of the mobile telephone network and means for receiving the test message, together with processor means for measuring a time interval between the test message being sent and being received.
